(19) United States
(12) Patent Application Publication
(10) Pub. No.: US 2007/0241738 A1
(43) Pub. Date: Oct. 18, 2007

(54) Start up circuit apparatus and method

(76) Inventors: Dalius Baranauskas, Pacific Palisades, CA (US); Denis Zelenin, Carlsbad, CA (US); Pasur Sengottaiyan, Carlsbad, CA (US)

Correspondence Address: PULSE-LINK, INC., 1969 KELLOGG AVENUE, CARLSBAD, CA, 92008, US

(21) Appl. No.: 11/402,497

(22) Filed: Apr. 12, 2006

(51) Int. Cl. G05F 3/20

(52) U.S. Cl. 323/316

(57) ABSTRACT

A start-up circuit for electronic circuits is provided. In one embodiment, the circuit uses a smaller capacitor and a current amplification means to force a larger capacitor to reach a charged state in a reduced time. The present invention is useful in any type of electronic circuit where fast start-up times are desirable. The present invention is especially useful in portable electronics, such as wireless communication devices, where minimal power consumption is desired. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention generally relates to electronic circuits. More particularly, the invention concerns a start-up circuit.

### BACKGROUND OF THE INVENTION

The Information Age is upon us. Access to vast quantities of information through a variety of different communication systems is changing the way people work, entertain themselves, and communicate with each other. Faster, more capable communication technologies are constantly being developed. For the manufacturers and designers of these new technologies, achieving low power consumption is becoming an increasingly difficult challenge. Low power consumption is important as it directly affects the battery life of portable electronic devices.

The wireless device industry, which includes portable devices, has recently seen unprecedented growth. With the growth of this industry, communication between wireless devices has become increasingly important. There are a number of different technologies for inter-device communications. Radio Frequency (RF) technology has been the predominant technology for wireless device communications. Alternatively, electro-optical devices have been used in wireless communications. Electro-optical technology suffers from low ranges and a strict need for line of sight. RF devices therefore provide significant advantages over electro-optical devices.

Conventional RF technology employs continuous sine waves that are transmitted with data embedded in the modulation of the sine waves' amplitude or frequency. For example, a conventional cellular phone must operate at a particular frequency band of a particular width in the total frequency spectrum. Specifically, in the United States, the Federal Communications Commission has allocated cellular phone communications in the 800 to 900 MHz band. Generally, cellular phone operators divide the allocated band into 25 MHz portions, with selected portions transmitting cellular phone signals, and other portions receiving cellular phone signals

Another type of communication technology is ultra-wideband (UWB). UWB technology can be fundamentally different from conventional forms of RF technology. One type of UWB employs a “carrier free” architecture, which does not require the use of high frequency carrier generation hardware; carrier modulation hardware; frequency and phase discrimination hardware or other components employed in conventional frequency domain communication systems.

Within UWB communications, several different types of networks, each with their own communication protocols are envisioned. For example, there are Local Area Networks (LANs), Personal Area Networks (PANs), Wireless Personal Area Networks (WPANs), sensor networks and others. Each network may have its own communication protocol.

Most of these forms of communications can be implemented in portable electronic devices. In these types of devices, power consumption and therefore battery life is of significant importance. In a number of technologies, high data rate devices are relatively power consumptive. However, the desire high data rate communication between portable devices directly conflicts with an equal desire for extended battery life. One approach is conservation, which requires the shutdown non-critical circuits when they are not in use. A significant drawback to this approach is the time necessary to restart the circuit when it is needed.

Therefore, there exists a need for a fast shutdown and start-up circuit for electronics contained within portable, and other types of electronic devices.

### BRIEF DESCRIPTION OF THE DRAWINGS

Various embodiments of the present invention taught herein are illustrated by way of example, and not by way of limitation, in the figures of the accompanying drawings, in which:

FIG. 1 is an illustration of different communication methods;

FIG. 2 is an illustration of two ultra-wideband pulses;

FIG. 3 depicts the current United States regulatory mask for outdoor ultra-wideband communication devices;

FIG. 4A illustrates transmit and receive frames and the guard time between the frames;

FIG. 4B illustrates power-up time periods prior to transmission and reception of the frames illustrated in FIG. 4A.

FIG. 5 illustrates a conventional circuit comprising a current source and current mirrors;

FIG. 6 illustrates a circuit consistent with one embodiment of the present invention;

FIG. 7 illustrates a circuit consistent with another embodiment of the present invention;

FIG. 8A illustrates a timing diagram of a conventional electronic circuit; and

FIG. 8B illustrates a timing diagram of a circuit constructed according to the present invention.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well-known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides a novel start-up circuit for communications devices. In one embodiment of the present invention comprises a capacitor that is charged by a current source. The current source is mirrored to provide a larger current to charge a larger capacitor. One feature of this embodiment is that the larger capacitor provides stability to the circuit while the time required to bring the circuit to an operational point is reduced.

The present invention circuit is particularly useful, but not limited to, applications in portable electronics devices where minimal power consumption is desired. Some forms of portable electronics may employ one, or more wireless communication technologies. One type of communication technology is ultra wideband (UWB). One embodiment of the present invention contemplates a portable communication device that employs UWB technology. This embodiment may employ a “burst” communication mode, because data rates achievable using UWB may exceed the portable devices' capacity to process the data. In this application, the UWB-enabled portable device may transmit at a very high data rate for a short period of time (i.e., “burst”) then shut down, to conserve power and battery life. In this embodiment, rapid start-up circuits may help to minimize power consumption.

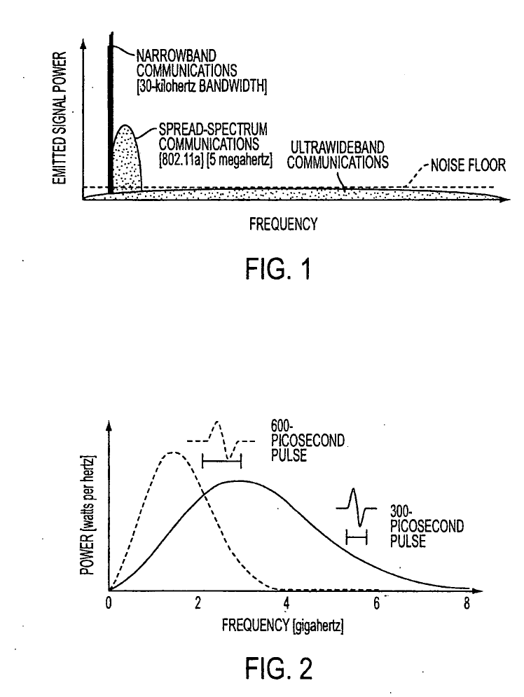

The embodiments of the present invention discussed below may be used with ultra-wideband (UWB) communication technology, as well as other forms of communication technology. Referring to FIGS. 1 and 2, impulse-type UWB communication employs discrete pulses of electromagnetic energy that are emitted at, for example, nanosecond or picosecond intervals (generally tens of picoseconds to a few nanoseconds in duration). For this reason, this type of ultra-wideband is often called “impulse radio.” That is, impulse-type UWB pulses may be transmitted without modulation onto a sine wave, or a sinusoidal carrier, in contrast with conventional carrier wave communication technology. Impulse-type UWB may operate in virtually any frequency band and in some applications may not require the use of power amplifiers.

An example of a conventional carrier wave communication technology is illustrated in FIG. 1. IEEE 802.11a is a wireless local area network (LAN) protocol, which transmits a sinusoidal radio frequency signal at a 5 GHz center frequency, with a radio frequency spread of about 5 MHz. As defined herein, a carrier wave is an electromagnetic wave of a specified frequency and amplitude that is emitted by a radio transmitter in order to carry information. The 802.11 protocol is an example of a carrier wave communication technology. The carrier wave comprises a substantially continuous sinusoidal waveform having a specific narrow radio frequency (5 MHz) that has a duration that may range from seconds to minutes.

In contrast, an ultra-wideband (UWB) pulse may have a 2.0 GHz center frequency, with a frequency spread of approximately 4 GHz, as shown in FIG. 2, which illustrates two typical impulse-type UWB pulses. FIG. 2 illustrates that the shorter the UWB pulse in time, the broader the spread of its frequency spectrum. This is because bandwidth is inversely proportional to the time duration of the pulse. A 600-picosecond UWB pulse can have about a 1.8 GHz center frequency, with a frequency spread of approximately 1.6 GHz and a 300-picosecond UWB pulse can have about a 3 GHz center frequency, with a frequency spread of approximately 3.3 GHz. Thus, UWB pulses generally do not operate within a specific frequency, as shown in FIG. 1. In addition, either of the pulses shown in FIG. 2 may be frequency shifted, for example, by using heterodyning, to have essentially the same bandwidth but centered at any desired frequency. And because UWB pulses are spread across an extremely wide frequency range, UWB communication systems allow communications at very high data rates, such as hundreds of Mega-bits per second or greater, including Giga-bits per second.

Several different methods of ultra-wideband (UWB) communications have been proposed. For wireless UWB communications in the United States, all of these methods must meet the constraints recently established by the Federal Communications Commission (FCC) in their Report and Order issued Apr. 22, 2002 (ET Docket 98-153). Currently, the FCC is allowing limited UWB communications, but as UWB systems are deployed, and additional experience with this new technology is gained, the FCC may revise its current limits and allow for expanded use of UWB communication technology.

The FCC April 22 Report and Order requires that UWB pulses, or signals must occupy greater than 20% fractional bandwidth or 500 Mega-Hertz of radio frequency, whichever is smaller. Fractional bandwidth is defined as 2 times the difference between the high and low 10 dB cutoff frequencies divided by the sum of the high and low 10 dB cutoff frequencies. Specifically, the fractional bandwidth equation is:

$$Fractional Bandwidth = 2 \frac{{f}_{h} - {f}_{l}}{{f}_{h} + {f}_{l}}$$

where fₕ is the high 10 dB cutoff frequency, and fₗ is the low 10 dB cutoff frequency.

Stated differently, fractional bandwidth is the percentage of a signal's center frequency that the signal occupies. For example, a signal having a center frequency of 10 MHz, and a bandwidth of 2 MHz (i.e., from 9 to 11 MHz), has a 20% fractional bandwidth. That is, center frequency, f_{c}=(fₕ+fₗ)/2

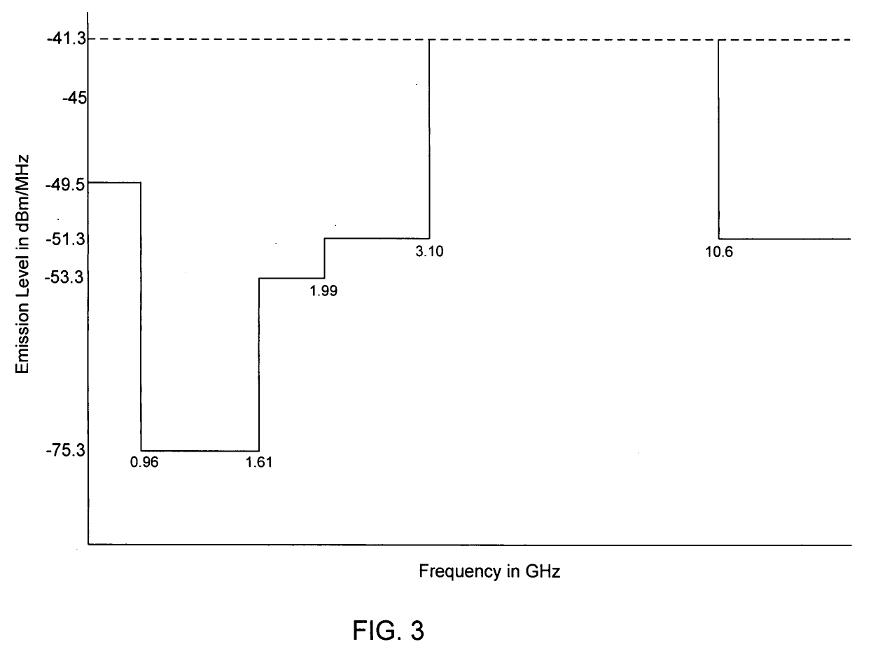

FIG. 3 illustrates the ultra-wideband emission limits for indoor systems mandated by the April 22 Report and Order. The Report and Order constrains UWB communications to the frequency spectrum between 3.1 GHz and 10.6 GHz, with intentional emissions to not exceed −41.3 dBm/MHz. The report and order also establishes emission limits for hand-held UWB systems, vehicular radar systems, medical imaging systems, surveillance systems, through-wall imaging systems, ground penetrating radar and other UWB systems. It will be appreciated that the invention described herein may be employed indoors, and/or outdoors, and may be fixed, and/or mobile, and may employ either a wireless or wire media for a communication channel.

Additionally, the International Telecommunications Union Task Group 1/8 (ITU-TG 1/8) is currently debating ITU recommendations for UWB communications. In some countries the regulations adopted for UWB communications will differ from the FCC definition, but should be similar in nature. For example, the Japanese Ministry of Internal Affairs and Communications (MIC) is currently debating the allowance of UWB in Japan. In this debate one proposal is to allow UWB communications in two frequency bands, one from 3.4 GHz to 4.8 GHz, the other from 7.25 GHz to 10.6 GHz. ITU proposals submitted by the European Conference of Postal and Telecommunications Administration (CEPT) would allow UWB transmission only above 6 GHz. A definition of UWB therefore may not be limited to specific frequency bands employed.

Generally, in the case of wireless communications, a multiplicity of UWB signals may be transmitted at relatively low power density (Milli-Watts per Mega-Hertz). However, an alternative UWB communication system, located outside the United States, may transmit at a higher power density. For example, UWB signals may be transmitted between 30 dBm to −50 dBm.

Communication standards committees associated with the International Institute of Electrical and Electronics Engineers (IEEE) are considering a number of ultra-wideband (UWB) wireless communication methods that meet the constraints established by the FCC. One UWB communication method may transmit UWB pulses that occupy 500 MHz bands within the 7.5 GHz FCC allocation (from 3.1 GHz to 10.6 GHz). In one embodiment of this communication method, UWB pulses have about a 2-nanosecond duration, which corresponds to about a 500 MHz bandwidth. The center frequency of the UWB pulses can be varied to place them wherever desired within the 7.5 GHz allocation. In another embodiment of this communication method, an Inverse Fast Fourier Transform (IFFT) is performed on parallel data to produce 122 carriers, each approximately 4.125 MHz wide. In this embodiment, also known as Orthogonal Frequency Division Multiplexing (OFDM), the resultant UWB pulse, or signal is approximately 506 MHz wide, and has approximately 242-nanosecond duration. It meets the FCC rules for UWB communications because it is an aggregation of many relatively narrow band carriers rather than because of the duration of each pulse.

Another UWB communication method being evaluated by the IEEE standards committees comprises transmitting discrete UWB pulses that occupy greater than 500 MHz of frequency spectrum. For example, in one embodiment of this communication method, UWB pulse durations may vary from 2 nanoseconds, which occupies about 500 MHz, to about 133 picoseconds, which occupies about 7.5 GHz of bandwidth. That is, a single UWB pulse may occupy substantially all of the entire allocation for communications (from 3.1 GHz to 10.6 GHz).

Yet another UWB communication method being evaluated by the IEEE standards committees comprises transmitting a sequence of pulses that may be approximately 0.7 nanoseconds or less in duration, and at a chipping rate of approximately 1.4 Giga pulses per second. The pulses are modulated using a Direct-Sequence modulation technique, and is known in the industry as DS-UWB. Operation in two bands is contemplated, with one band is centered near 4 GHz with a 1.4 GHz wide signal, while the second band is centered near 8 GHz, with a 2.8 GHz wide UWB signal. Operation may occur at either or both of the UWB bands. Data rates between about 28 Mega-bits/second to as much as 1,320 Mega-bits/second are contemplated.

Another method of UWB communications comprises transmitting a modulated continuous carrier wave where the frequency occupied by the transmitted signal occupies more than the required 20 percent fractional bandwidth. In this method the continuous carrier wave may be modulated in a time period that creates the frequency band occupancy. For example, if a 4 GHz carrier is modulated using binary phase shift keying (BPSK) with data time periods of 750 picoseconds, the resultant signal may occupy 1.3 GHz of bandwidth around a center frequency of 4 GHz. In this example, the fractional bandwidth is approximately 32.5%. This signal would be considered UWB under the FCC regulation discussed above.

Thus, described above are four different methods of ultra-wideband (UWB) communication. It will be appreciated that the present invention may be employed by any of the above-described UWB methods, or others yet to be developed. One characteristic of UWB communications is the bandwidth occupied by UWB signals is very large and the data rates are very high. Traditionally, high data rate wireless devices consume more power than lower data rate devices. This characteristic makes it difficult to design circuits for portable electronic applications where battery life is an important consideration. Many electronic devices that employ conventional, or UWB communication technology can benefit from the circuits disclosed herein.

Specific embodiments of the invention will now be further described by the following, non-limiting examples which will serve to illustrate various features. The examples are intended merely to facilitate an understanding of ways in which the invention may be practiced and to further enable those of skill in the art to practice the invention. Accordingly, the examples should not be construed as limiting the scope of the invention.

The present invention is useful in any electronic circuit, and especially in electronic circuits where accelerated start-up times are desired. In a preferred embodiment, the circuits described herein are employed in portable wireless communication devices. The present invention is particularly useful in portable communication devices that employ UWB communication technology. For example, some applications foreseen for a portable communication device that employs UWB communication technology may be a mode where the portable device bursts at a high data rate and then either shuts down, or “sleeps” for a time period. For example, in many wireless portable devices, the data processing capability of the device may be substantially lower than the data rate capability provided by the UWB communication technology. When transferring a file from one portable device to another or from a portable device to any other type of device, it may be advantageous to transmit at a very high rate, and then shut down while the receiving device processes the received data.

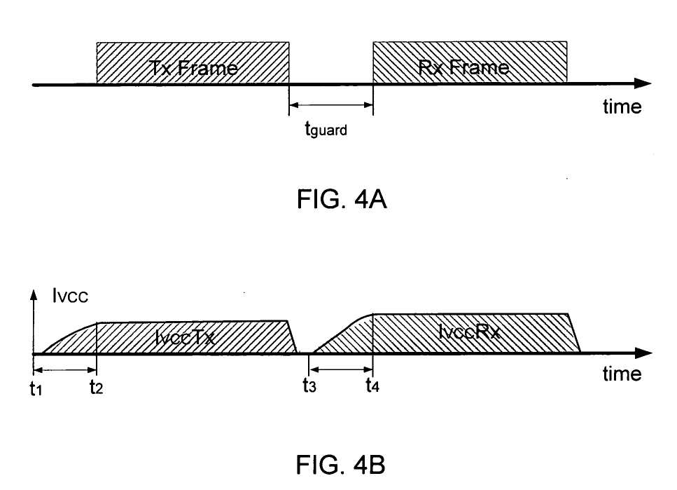

Referring now to FIG. 4A, in communication systems that use “fames” to transmit data, there may be breaks between the transmission and/or reception of frames. For example, a transmitting device may transmit a frame (Tx Frame), and then have a guard period (tguard) before receiving a frame (Rx Frame). These time periods are usually negotiated or assigned by a common communication protocol running within each device. During the Tguard time a device may power down some portion of its circuitry in order to save power and extend battery life.

However, as shown in FIG. 4B, in some instances the power-up time period before transmission can be initiated (t2-t1) and the power-up time period required before the receiver can be started (t4-t3) can comprise a significant time period. These power-up periods limit the amount of time a device can remain in a low power state. Therefore, it is advantageous to minimize the start-up time of the transmit and receive circuits. One advantage of the present invention is that by minimizing a circuits' start-up time, the guard time intervals (tguard) may be reduced. In some applications, such as portable devices the guard time intervals may allow for a “power down” mode. In devices where battery life is not a significant issue, the reduced start-up time may allow for higher data throughput by placing frames closer together in time.

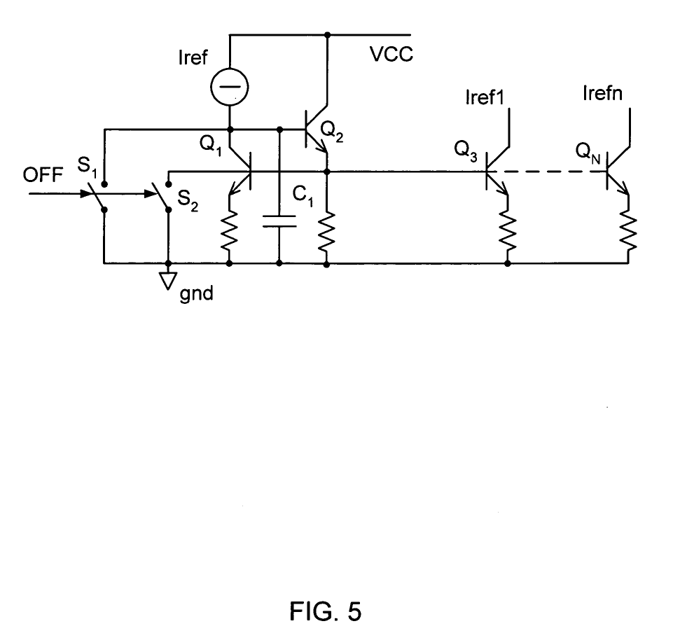

Referring now FIG. 5, which illustrates a portion of an electronic circuit usually used for generating biasing currents in transistor circuits. In steady state operation reference current Iref flows through transistor Q1 and is mirrored in transistors Q3-QN. Transistor Q2 provides base current for Q1 and Q3-QN. Capacitor C1 is provided for bypassing the bias voltage at the base of transistor Q2 and to ensure the stability of the negative feedback loop through Q2 and Q1. In shut down state both switches (S1 and S2) are ON (i.e., closed). S1 short circuits Iref to ground. S2 ensures short circuiting of any reverse collector-base current produced in Q3-QN, which may be present as a result of avalanche carrier multiplication in the collector-base region. The circuit is started by turning OFF switches S1, S2 (i.e., open, as shown). One limitation of this circuit, in terms of start-up time is the time to charge capacitor C1. Upon start-up, a portion of current Iref provides the charge to capacitor C1. The charge time may be modeled as

$$Δ t = \frac{Δ v * C 1}{Iref}$$

where Δv is the voltage increase on the capacitor, C1 is the capacitance of the capacitor, and Iref is the current charging the capacitor. The charging time is therefore dependent on the current charging the capacitor and on the size, or capacitance of the capacitor. That is, the higher the capacitance, and the smaller the charging current, the longer it takes to charge.

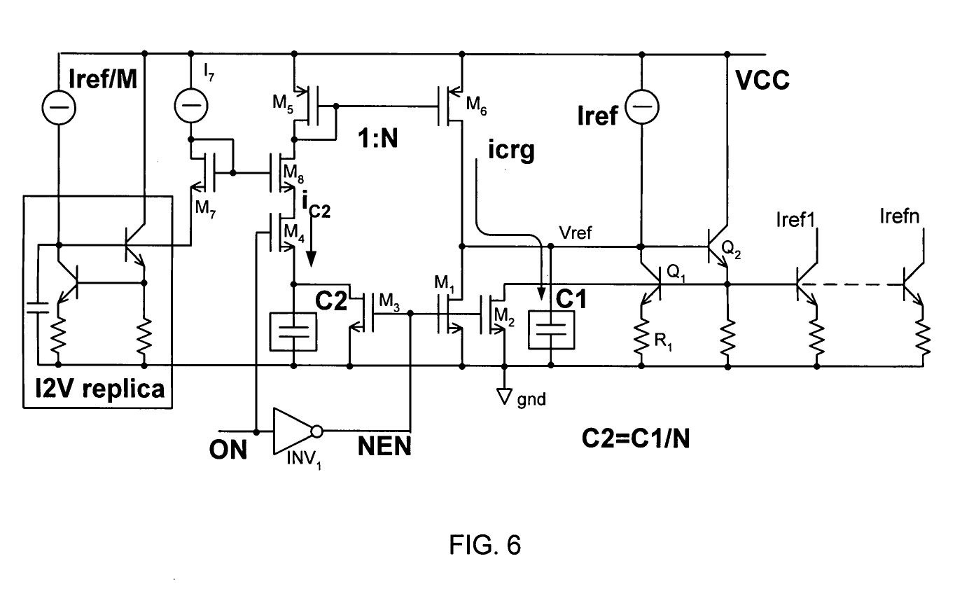

One embodiment of the present invention, illustrated in FIG. 6, shows an accelerated start-up circuit. In this embodiment, capacitor C2 is selected to have a capacitance N times smaller than capacitor C1, where N is number larger than 1. When the circuit illustrated in FIG. 6 is in a low-power or OFF state, the ON signal is low. The ON signal is inverted by inverter INV1 to provide a high signal to transistors M1, M2, and M3. In an ON state, M2 provides a path for any leakage current to reach the lower voltage level gnd. In like manner transistor M1 provides a path for Iref to reach the lower voltage level gnd., and M3 keeps capacitor C2 short-circuited.

When start-up of the circuit is initiated, the ON signal goes high and remains high during normal operation of the circuit. The ON signal turns on transistor M4, which allows current i_{C2} to charge capacitor C2. INV1 provides a low potential to signal NEN, which turns off transistors M3, M1, and M2. The current mirror circuit that includes transistors M5 and M6 is designed to provide a current icrg to charge capacitor C1. This current mirror circuit may be designed to multiply current i_{C2} by the same factor N, allowing the larger capacitor C1 to charge faster. It is anticipated that the relative capacitance of C1 is N times larger than C2. Once capacitors C1 and C2 have achieved complete charge, the current flow through those capacitors goes to zero. This effectively places M4, ic2, M5, and M6, in a “zero” or negligible current state. The charge on capacitor C1 provides bias voltages and stability to the remaining current sources Iref1 to Irefn in a similar manner as described above with reference to FIG. 5.

Embodiments of the present invention start up circuit, ensures that the voltage produced on C1 (VC1) during accelerated startup matches the steady state value. If the voltage across C1 exceeds its steady state value, Iref overshoot may result. The steady state voltage VC1 is defined as: V_{C1}=V_{be2}+V_{be1}+I_{ref}R1. An I2V replica with a comparator on M7 and M8 biased by 17 are employed. Iref/M current flows through I2V replica. M may be any number greater or equal to 1. As the transistors in I2V replica circuit are also scaled down by M, the voltage produced on source of M7 matches VC1 in steady state operation. When ON goes to high, C2 is charged by i_{C2}. When the voltage on the source of M8 matches the voltage on source of M7, i_{C2} reduces down to 17 (in case of equal size of M7 and M8). Further voltage VC2 increasing stops as the current stops to flow when M8 switches OFF. The charge on C2 created by i_{C2} is N times less than necessary for C1 to be charged to VC1. The current mirror on M5 and M6 multiplies i_{C2} N times to obtain i_{crg} feeding into C1 and producing VC1 matching that in steady state operation.

One feature of this embodiment of the present invention is that by using capacitor C2 and its associated circuit, the charge time of capacitor C1 is reduced to that of capacitor C2. One advantage of using a small capacitor for C2 is that the current i_{C2} can be relatively small, minimizing power consumption during start-up. Additionally, fabrication of capacitor C2 will occupy substantially smaller space than a larger capacitor.

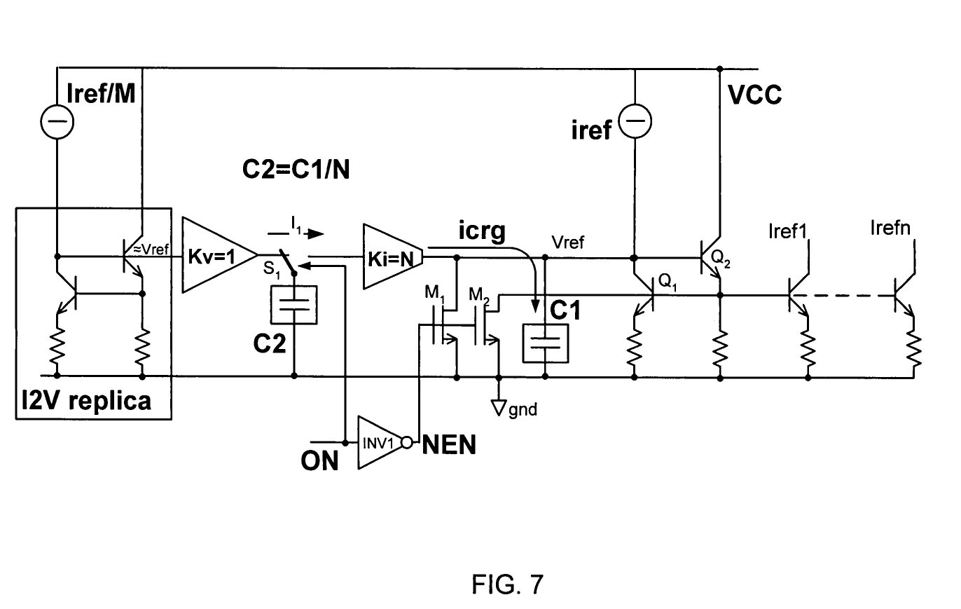

Referring now to FIG. 7, which illustrates another embodiment of the present invention. The charge on capacitor C1 provides bias voltages and stability to the remaining current sources Iref1 to Irefn in a similar manner as described above with reference to FIG. 5. A voltage amplifier with Kv=1 provides a low impedance node for accelerated charging of C2. When this embodiment is in the low power state the ON signal is low and switch S1 is in the position as shown. In this state capacitor C2 is allowed to charge to a voltage approximately equal to Vref. The ON signal is inverted by inverter INV1, which provides a high signal NEN to turn on transistors M1 and M2. Transistors M1 and M2 provide a current path for Iref and any leakage currents to reach a lower voltage state gnd. When start-up is desired the ON signal goes high which places switch S1 in the alternate position. The charged capacitor C2 provides the charge to capacitor C1 through current amplifier Ki. Similar to the circuit in FIG. 6, the capacitance of C1 is N times larger than the capacitance of capacitor C2, and the gain of current amplifier Ki is N, where N is a number larger than 1. In this state, the inverter INV1 provides a low to turn off transistors M1 and M2, thereby removing the path to the lower voltage state gnd. When capacitor C1 reaches a charged state, it provides bias voltages and stability to the current mirror stages Iref1 through Irefn.

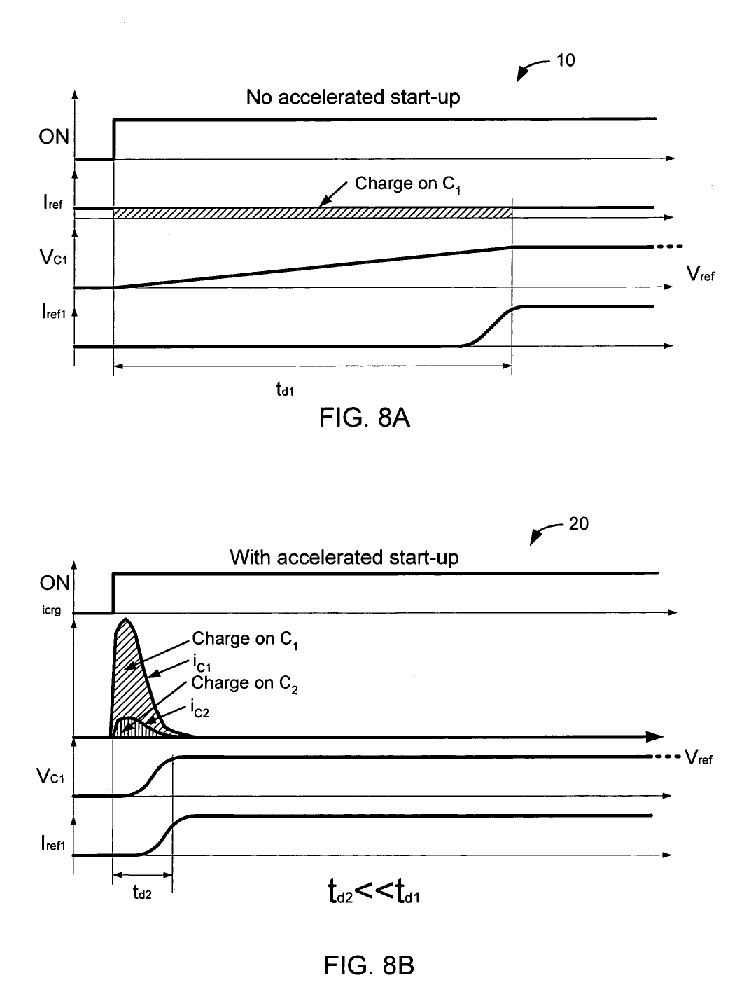

Referring now to FIGS. 8A and 8B, which illustrate the differences in transition times between circuits not employing the present invention and ones incorporating the present invention. In FIG. 8A, the timing diagram 10 shows that following the transition of the ON signal, current Iref is charging capacitor C1. During time period t_{d1} the voltage Vc1 across capacitor C1 increases until it reaches a complete charge at voltage level Vref. Current provided by current source Iref1 is delayed in time until capacitor C1 has reached a level to provide proper bias voltage to the circuit. This is contrasted with FIG. 8B, which illustrates timing diagram 20, that is representative of a circuit employing the present invention.

In timing diagram 20 when the ON signal transitions to a high state, the charging currents i_{C1} and i_{C2} are substantially higher than Iref in timing diagram 10. It is important to note that charging current i_{C1} is N times larger than charging current i_{C2}. The larger currents i_{C1} and i_{C2} provide for faster charge times for capacitors C1 and C2. This results in VC1 reaching an operational state of Vref in a much shorter time period t_{d2}. At this operational state current source Iref1 and associated current mirrors will reach operational readiness in time period t_{d2} instead of t_{d1}.

Thus, it is seen that an apparatus for acceleration of start-up of electronic circuits is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A method of initializing current sources in an electronic circuit, the method comprising the steps of:
charging a first capacitor with a first charging current;
mirroring the first current to provide a second current;
charging a second capacitor with the second current; and
providing a bias voltage to a current source circuit from a charge on the second capacitor.

2. The method of claim 1, wherein the first capacitor has a capacitance that is N times smaller that a capacitance of the second capacitor, N being a number greater than 1.

3. The method of claim 1, wherein the second current is N times larger than that the first current.

4. A method of initializing current sources in an electronic circuit, the method comprising the steps of:
transitioning a first signal from a low state to a high state;
switching the state of a first transistor with the first signal to provide a path for a first current to charge a first capacitor;
inverting the first signal to produce a second signal;
switching the state of second transistor with the second signal to remove a path for a second current to reach a low voltage;
multiplying the first current by a value greater than I to produce a third current; and
charging a second capacitor with the third current.

5. The method of claim 4, wherein a capacitance ratio of the second capacitor to the first capacitor is greater than 1.

6. The method of claim 4, further comprising the step of providing a bias voltage from the second capacitor to a current source circuit.

7. A circuit comprising:
a current source;
a first transistor having a first connection to the current source, the transistor having a second connection to a control signal and a third connection to a first capacitor;
a current amplification circuit connected to the current source; and
a second capacitor connected to the current amplification circuit.

8. The circuit of claim 7, further comprising an inverter connected to the control signal, and further connected to at least a second transistor.

9. The circuit of claim 7, further comprising a second current source circuit connected to the second capacitor.

10. The circuit of claim 7, wherein a capacitance ratio of the second capacitor to the first capacitor is greater than 1.

11. The circuit of claim 7, wherein a ratio of a current provided by the first current source to a current provided by the current amplification circuit is greater than 1.
